(19) United States
(12) Patent Application Publication
(10) Pub. No.: US 2002/0135175 A1
(43) Pub. Date: Sep. 26, 2002

(54) Safety harness

(75) Inventor: Carl-Jurgen Schroth, Soest (DE)

Correspondence Address: Henry M. Feiereisen, Suite 3220, 350 Fifth Avenue, New York, NY, 10118, US

(73) Assignee: SCHROTH SAFETY PRODUCTS GMBH, Arnsberg (DE)

(21) Appl. No.: 10/105,077

(22) Filed: Mar. 22, 2002

(30) Foreign Application Priority Data
Mar. 23, 2001 (DE) 101 14 343.5

(51) Int. Cl. B60R 22/00

(52) U.S. Cl. 280/801.1

(57) ABSTRACT

A safety harness includes a lap belt, two shoulder belts and a buckle for connecting the shoulder belts to the lap belt. The shoulder belts rest flatly against the torso and shoulders of a person and have a curved configuration. Each shoulder belt defines a sternum-proximal belt edge and a sternum-distal belt edge and has at least a central length portion in which the sternum-proximal belt edge is shorter in length than the sternum-distal belt edge.

### CROSS-REFERENCES TO RELATED APPLICATIONS

This application claims the priority of German Patent Application, Serial No. 101 14 343.5, filed Mar. 23, 2001, pursuant to 35 U.S.C. 119(a)-(d), the subject matter of which is incorporated herein by reference.

### BACKGROUND OF THE INVENTION

The present invention relates, in general, to a passenger restraining system, and more particularly to a safety harness of a type having at least a lap belt, two shoulder belts and a buckle for connecting the shoulder belts to the lap belt.

Safety harnesses of this type are effective only when the individual belts are able to properly embrace the body of passengers of aircrafts, watercrafts or land crafts and in addition rest flatly against those body portions that absorb the load. These load-absorbing body portions include the pelvis, torso and shoulders of the person. Safety harnesses and other belt systems have been developed, tested and built primarily for frontal impact. The protection of a person's head involves inflatable restraining systems which are sophisticated enough to provide sufficient protection in the event of a collision that is not at a right angle. In the event of a side collision, common knowledge was based on the assumption that a colliding vehicle or other obstacle penetrates into the vehicle and contacts prematurely the inner structure and the passengers inside. Armrests and headrests of a vehicle predominantly assume restraining functions in the event of a collision from the rear.

A particular problem involves racing cars and aircrafts where safety harnesses are oftentimes used in the absence of assisting inflatable restraining systems, and the shoulder belts are anchored symmetrically behind the user. Hereby, the shoulder belts are united behind the passenger in order to properly hold the passenger. As a consequence of the short distances between the passenger and the anchor points to the vehicle, the shoulder belts are not fully brought together but only approach one another because of the spacing between the anchor points. By bringing the shoulder belts closely together behind the passengers, it is intended to provide a momentary good force absorption via the shoulder belts with the vehicle in the event of a crash from the front or a crash at an angle while the shoulder belts, which are distal to the impact direction, remain securely on the shoulders. In this way, the person's upper body is prevented from wiggling out of the belt system.

The absence of inflatable restraining systems in racing cars and aircrafts resulted in the development of a restraining system known under the term HANS which is short for “Head And Neck Support”. HANS represents a firm collar structure which has two forward ends extending to about breast height, is looped over the shoulders around the neck and includes an upwardly projecting ruff to which the helmet of a passenger is secured on both sides by means of flexible connections. This collar structure is held by the shoulder belts of a safety harness against the person's body. As the collar structure rests on the shoulders, the concave configuration of the shoulder area of a passenger is negated, while the collar structure can be kept narrow enough in this area to prevent interference, when a driver assumes a more reposed position, in particular in racing cars of formula racing, so as to allow the arms of the driver to comfortably reach the steering wheel and other gadgets in the vehicle. However, in the event of a front end collision, there is a danger that the shoulder belts slide down from the collar structure.

As the collar structure according to HANS sufficiently covers the neck with respect to the shoulder belts that extend over the shoulders, the anchor points for the shoulder belts can be closely moved together behind the back of the neck. In this way, the user's upper body can be better protected against lateral motions. In the event of a crash at an angle with respect to the longitudinal direction of the vehicle, a separation of the upper body from the shoulder belt that is further away with respect to the impact direction is made more difficult. An approximation of the anchor points behind the back of a person's neck results, however, in a tighter partial embracing of the collar structure so that sternum-distal belt edges of the shoulder belts and sternum-proximal belt edges of the shoulder belts have different length between the attachment to the buckle and the anchor points. As a consequence of these geometric facts, the shoulder belts rest only at their sternum-distal belt edges on the collar structure so that the shoulder belts tend even more to slide off the collar structure. Moreover, in the event of a crash, the exerted load will not act on the shoulder belts over their entire width but only upon those areas that adjoin the sternum-distal belt edges. Consequently, there is an increased danger belt rupture. Designing the shoulder belts wider may conceivably avoid this shortcoming; However, this approach is accompanied by the drawback that the stretching capability in the actual load zone of the shoulder belt is significantly reduced so that passengers are exposed to higher peak loads. Another approach involves the provision of the collar structure of HANS with an inclination that increases in the direction of the passenger's neck. However, this is disadvantageous because such a ramp further promotes a sliding off of the shoulder belts. Still another approach involves the provision of a breach of the shoulder belts in the neck area and to hingedly join the length portions of the split shoulder belts by means of metal rings. This suffers shortcomings as well because there is no longer an even frictional engagement with a carried collar structure. In other words, the absence of a HANS collar structure endangers a passenger in the neck area by the presence of such metal parts

It would therefore be desirable and advantageous to provide an improved safety harness, which obviates prior art shortcomings and, especially in conjunction with a HANS collar structure, exhibits an improved belt guidance while improving the safety factor for a passenger.

### SUMMARY OF THE INVENTION

According to one aspect of the present invention, a safety harness, includes a lap belt, and two shoulder belts intended for connection to the lap belt and resting flatly against the torso and shoulders of a person; wherein each said shoulder belt defines a sternum-proximal belt edge and a sternum-distal belt edge and has at least a length portion in which the sternum-proximal belt edge is shorter in length than the sternum-distal belt edge.

The present invention resolves prior art problems by providing shoulder belts, which are guided in an arcuate pattern across the torso of a user and rest flatly against the torso and shoulders of the user. The arcuate flow of the shoulder belts can be realized during production of the shoulder belts by configuring the sternum-proximal belt edges shorter in length than the sternum-distal belt edges. This configuration may be provided over the entire length of the shoulder belts or only along a certain length portion, in particular the central length portion. Shoulder belts of this type ensure a steady flat contact along the load-absorbing body portions of a user while properly embracing the neck. Sliding off of such shoulder belts from a HANS collar structure is effectively prevented so that the risk of belt rupture is eliminated. There is no need to increase the thickness of the shoulder belts so that the belt stretching capability is not inhibited. Moreover, the user's body is not exposed to higher peak loads.

According to another feature of the present invention, the shoulder belts may have one or more wedge-shaped tucks in the length portion in order to realize belt edges of different length and the arcuate configuration of the shoulder belts.

According to another feature of the present invention, each shoulder belt may be separated in the length portions by at least one transverse cut to define two belt portions which are connected by a bridge band whose opposite ends overlap confronting ends of the belt portions in a wedge-shaped manner. The attachment of the bridge band to the belt portions may be implemented by one stitch or several suitable stitches. Of course, other load-absorbing and permanent connections are conceivable as well.

According to another feature of the present invention, a carrier band may be connected to the shoulder belt in the area of the sternum-proximal belt edge for placement upon the tuck or the bridge band. The carrier band enhances the strength in the event of a load caused by a crash and has a narrower configuration than the shoulder belt. The carrier band may be stitched to the shoulder belt or coupled by any other suitable connection and imparted with such stretching properties that its makeup resembles those belt zones that extend along the longer sternum-distal belt edge, even when considering the tear behavior of the tuck or bridge band.

According to another feature of the present invention, the shoulder belts may be made, at least partially, of plastic fibers constructed to shrink under heat exposure, wherein a zone adjacent to the sternum-proximal belt edge and a zone adjacent to the sternum-distal belt edge in the length portion of the shoulder belts are exposed to a same temperature over different time periods or to different temperatures over a substantially same time period. In this way, the areas exposed to a higher temperature are subject to greater length shrinkage to thereby realize the arcuate configuration of the shoulder belt. A person skilled in the art has at its disposal many plastic fibers that are suitable for use here. Examples include plastic fibers of polyamide, e.g. nylon, or polyester, which can be exposed to a temperature range of 130° C. to 280° C. over a time period in the range of 1 to 10 minutes, depending on the selected temperature.

According to another feature of the present invention, the shoulder belts may have a woven structure, which in the area of the length portion has an increasing number of wefts extending from the sternum-distal belt edge to the sternum-proximal belt edge and/or wefts with thicker cross section. The increase in numbers of the wefts may hereby implemented step-by-step or continuously and results in a respectively greater number of meandering structures of the warps and thus to a relative shortening of the sternum-proximal belt edge of the shoulder belts.

When weaving thicker wefts, the resultant greater meandering of the warps also leads to a relative shortening of the sternum-proximal belt edge. Moreover, the thickness of the sternum-proximal belt edge as a result of the use of thickened wefts leads to an increased acceptance of the safety harness because the danger of getting cut, in particular in the neck area, is diminished.

Suitably, the thicker wefts may be configured as monofilaments in order to prevent a greater compression of the thicker wefts with respect to the thinner warps.

According to another feature of the present invention, the shoulder belts may have a woven structure, which in the area of the length portion is so configured that warps, which extend from the sternum-distal belt edge to the sternum-proximal belt edge, have a longitudinal tension which uniformly increases or increases step-by-step.

Of course the afore-described measures for realizing the arcuate configuration of the shoulder belts may also be combined in any suitable manner.

According to another aspect of the present invention, a safety harness may also be constructed in a way to have a so-called double crotch belt, which can be constructed in a same manner as the shoulder belts according to the present invention. Thus, such arcuate crotch belts also adapt to a user's body contour so that the provision of a safety harness, in particular a six point safety harness, is possible for application in sporty vehicles for water use or land use or in aircrafts.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a half section of a frontal view of a person's upper body restrained by a safety harness according to the present invention;

FIG. 2 is an enlarged detailed view of a first embodiment of a length portion of a shoulder belt of the safety harness of FIG. 1;

FIG. 3 is an enlarged detailed view of a second embodiment of a length portion of a shoulder belt of the safety harness of FIG. 1;

FIG. 4 is an enlarged detailed view of a third embodiment of a length portion of a shoulder belt of the safety harness of FIG. 1;

FIG. 5 is an enlarged detailed view of a fourth embodiment of a length portion of a shoulder belt of the safety harness of FIG. 1;

FIG. 5a is a cutaway perspective view of the length portion of FIG. 5;

FIG. 6 is an enlarged detailed view of a fifth embodiment of a length portion of a shoulder belt of the safety harness of FIG. 1;

FIG. 6a is a cutaway view of the length portion of FIG. 6; and

FIG. 7 is an enlarged detailed view of a sixth embodiment of a length portion of a shoulder belt of the safety harness of FIG. 1.

### DETAILED DESCRIPTION OF PREFERRED EMBODIMENTS

Throughout all the Figures, same or corresponding elements are generally indicated by same reference numerals.

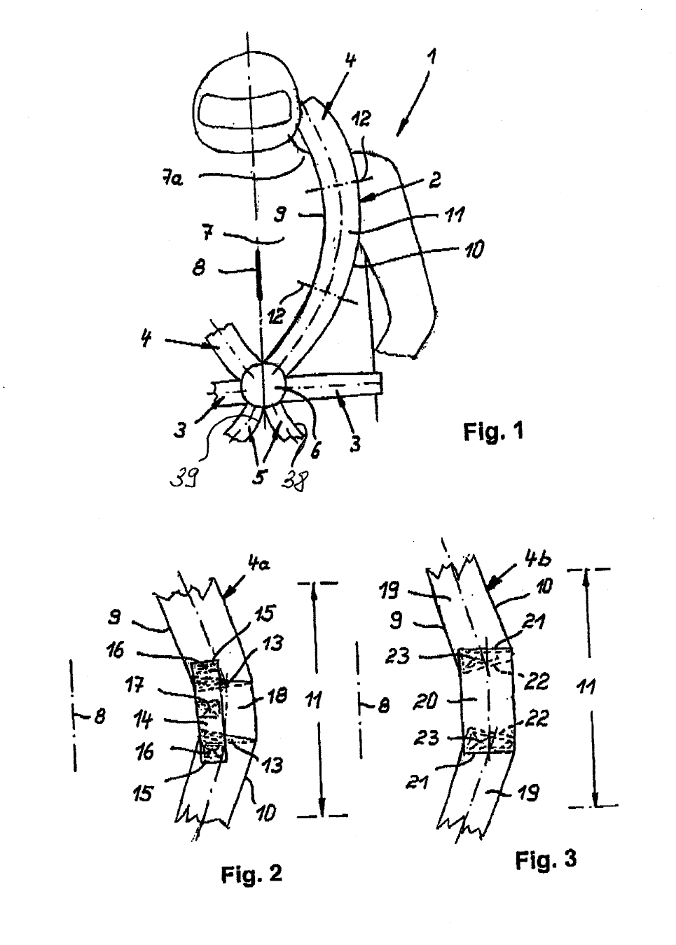

Turning now to the drawing, and in particular to FIG. 1, there is shown a half section of a frontal view of a user's upper body 1 restrained by a safety harness according to the present invention, generally designated by reference numeral 2 and configured in the form of a six-point safety harness. In the non-limiting example of FIG. 1, the person shown represents a driver of a racing car with torso 7, shoulder 7a and sternum 8 illustrated here only.

The safety harness2 includes a two-part lap belt 3 which extends around the user's pelvis, two shoulder belts 4 which extend across the torso 7 over the shoulder 7a, and two crotch belts 5 which extend between the user's legs. The lap belt 3, shoulder belts 4 and crotch belts 5 are connected together by a common central buckle 6. The shoulder belts 4 have an arcuate configuration to suit the load-absorbing contour of the user's torso 7 and define a sternum-proximal belt edge 9 and a sternum-distal belt edge 10. The flat engagement of the shoulder belts 4 against the torso 7 and shoulders 7a is realized by a shortening of the sternum-proximal belt edge 9 in comparison to the sternum-distal belt edge 10, including the belt areas adjacent to the belt edges 9, 10.

The arcuate formation of the shoulder belts 4 can be realized in various ways, as will now be described with reference to FIGS. 2 to 7. In describing the following Figures, like parts of the safety harness 2, in particular the shoulder belt 4, will be identified by corresponding reference numerals followed by a distinguishing lower case character.

In the embodiment of FIG. 2, each of the shoulder belts 4a has a central length portion 11, shown in FIG. 1 between the dashdot lines 12, which is implemented by wedge-shaped tucks 13. In this way, the sternum-proximal belt edge 9 is reduced in length and thus shorter than the sternum-distal belt edge 10. The tucks 13 are covered by a carrier band 14 which is narrower than the shoulder belt 4a and has ends 15 which are firmly stitched to the shoulder belt 4a. In addition, the carrier band 14 is also firmly stitched to the shoulder belt 4a between both tucks 13. The stitching zones are designated in FIG. 2 by reference numerals 16 and 17. The carrier band 14 is so configured as to have a strain behavior which stretches in like manner as the sternum-distal zone 18 of the shoulder belt 4a under load, even when also taking into account the tear behavior of the tucks 13.

In the embodiment of FIG. 3, each shoulder belt 4b is separated in the length portion 11 by a single traverse cut to define two belt portions 19. A bridge band 29 connects the belt portions 19 of the shoulder belt 4b together and has ends 21 which overlap confronting ends 22 of the belt portions 19 in a wedge-shaped manner. The overlapping ends 21, 22 are connected together by stitches 23. Also in this way, the sternum-proximal belt edge 9 becomes shorter in length than the sternum-distal belt edge 10.

Although not shown in the drawing, the carrier band 14 may, of course, suitably be sized and used for covering the bridge band 20 as well.

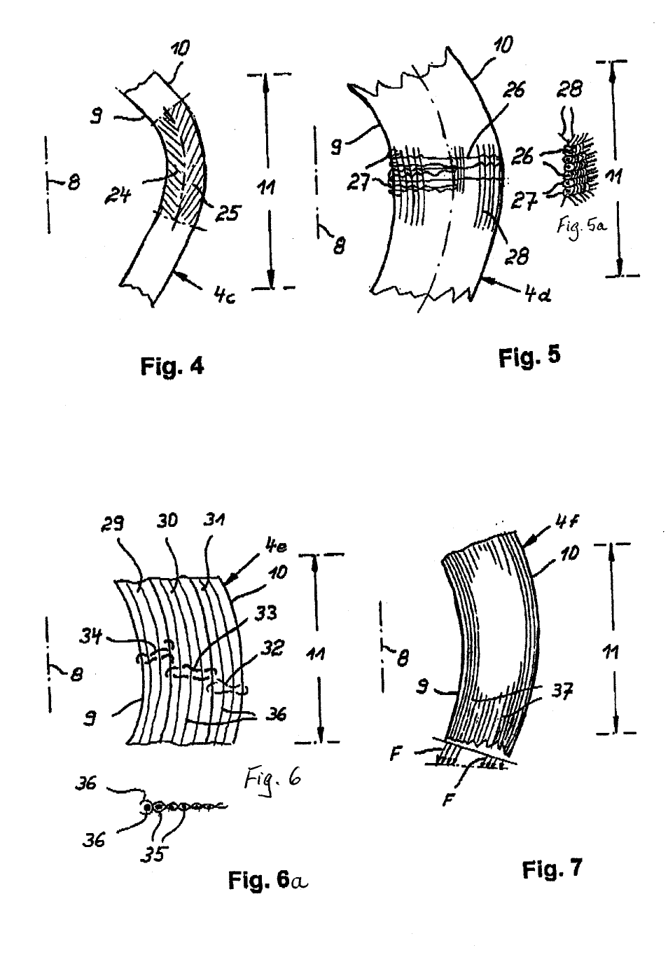

In the embodiment of FIG. 4, the length portion 11 of each shoulder belt 4c is made at least partially of plastic fibers which shrink when exposed to heat. In order to provide the shoulder belt 4c with the arcuate configuration, belt zones 24, 25, shown schematically in neighboring relationship to the belt edges 9, 10, are exposed to a same temperature over different time periods or to different temperatures over a substantially same duration. In this way, a gradual increase in shrinkage can be imparted from the sternum-distal belt edge 10 in the direction of the sternum-proximal belt edge 9, resulting in different lengths of the belt edges 9, 10. There are many different plastic fibers that can be employed here. Examples include plastic fibers of polyamide, e.g. nylon, or polyester, which can be exposed to a temperature range of 130° C. to 280° C. over a time period in the range of 1 to 10 minutes, depending on the selected temperature.

In the embodiment of FIG. 5, each shoulder belt 4d is woven, whereby the length portion 11 of the shoulder belt 4d is provided with an increasing number of wefts 26 from the sternum-distal belt edge 10 in the direction of the sternum-proximal belt edge 9. The increase in number of the wefts 26 from the belt edge 10 to the other belt edge 9 may be implemented gradually or step-by-step. As a consequence, a respectively greater number of meanders 27 of the warps 28 and thus a shortening of the sternum-proximal belt edge 9 compared to the length of the belt edge 10 can be established. FIG. 5a shows a perspective view of the length portion 11 with wefts 26 and warps 28.

In the embodiment of FIG. 6, each shoulder belt 4e is woven in belt zones 29, 30 between the sternum-proximal belt edge 9 and the sternum-distal belt edge 10 with wefts 32, 33, 34 of different thickness. This is also shown in detailed view of FIG. 6a. As a consequence of the increasingly more pronounced meandering 35 of the warps 36 from the belt edge 10 to the other belt edge 9, a shortening of the sternum-proximal belt edge 9 is realized in relation to the sternum-distal belt edge 10 as well as a shortening of the belt zone 31 in relation to the belt zone 30 and a shortening of the belt zone 30 in relation to the belt zone 29, thereby establishing the arcuate configuration of the shoulder belt 4e. The wefts 33, 34 of the belt zones 30, 29 may be made of monofilament yarns compared to the thinner wefts 32 of the belt zone 31.

In the embodiment of FIG. 7, each shoulder belt 4f is woven and can be imparted with an arcuate configuration by weaving the warps 37 with a warp tension F that increases steadily or in predetermined increments from the sternum-distal belt edge 10 in the direction of the sternum-proximal belt edge 9, so as to provide the belt edges 9, 10 with different length.

Although not shown in the Figures, it is certainly within the scope of the present invention to provide the crotch belts 5 of the safety harness 2 in a same manner as the shoulder belts 4 with an arcuate configuration through application of any of the afore-described ways. Accordingly, each crotch belt 5 defines a leg-proximal inner edge 38 and a leg-distal outer edge 39 and has at least a length portion in which the inner edge 38 is shorter in length than the outer edge 39.

While the invention has been illustrated and described as embodied in a safety harness, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A safety harness, comprising a lap belt; and two shoulder belts intended for connection to the lap belt and resting flatly against the torso and shoulders of a person, wherein each said shoulder belt defines a sternum-proximal belt edge and a sternum-distal belt edge and has at least a length portion in which the sternum-proximal belt edge is shorter in length than the sternum-distal belt edge.

2. The safety harness of claim 1, wherein the length portion is situated along a central location of the shoulder belt.

3. The safety harness of claim 1, wherein the shoulder belt has at least one wedge-shaped tuck in the length portion.

4. The safety harness of claim 1, wherein the shoulder belt is separated in the length portions by a transverse cut to define two belt portions, and further comprising at least one bridge band, having opposite ends which overlap confronting ends of the belt portions in a wedge-shaped manner, for connecting the belt portions.

5. The safety harness of claim 3, and further comprising a carrier band connected to the shoulder belt in the area of the sternum-proximal belt edge for placement upon the tuck.

6. The safety harness of claim 4, and further comprising a carrier band connected to the shoulder belt in the area of the sternum-proximal belt edge for placement upon the bridge band.

7. The safety harness of claim 1, wherein the shoulder belt is made, at least partially, of plastic fibers constructed to shrink under heat exposure, wherein a zone adjacent to the sternum-proximal belt edge and a zone adjacent to the sternum-distal belt edge in the length portion of the shoulder belt are exposed to a same temperature over different time periods or to different temperatures over a substantially same time period.

8. The safety harness of claim 7, wherein the plastic fibers are made of a material selected from the group consisting of polyamide and polyester.

9. The safety harness of claim 8, wherein the polyamide is nylon.

10. The safety harness of claim 7, wherein the plastic fibers are exposed to a temperature in the range from 130° C. to 280° C. over a time period from 1 to 10 minutes, depending on the selected temperature.

11. The safety harness of claim 1, wherein the shoulder belt has a woven structure which in the area of the length portion is configured in at least one of a pattern involving an increasing number of wefts extending from the sternum-distal belt edge to the sternum-proximal belt edge, and wefts which are thicker in cross section.

12. The safety harness of claim 11, wherein the thicker wefts in cross section are configured as monofilaments.

13. The safety harness of claim 1, wherein the shoulder belt has a woven structure which in the area of the length portion is so configured that warps, which extend from the sternum-distal belt edge to the sternum-proximal belt edge have a longitudinal tension which increases gradually or step-by-step.

14. The safety harness of claim 1, and further comprising two crotch belts adapted for connection to the shoulder belts and the lap belt, each said crotch belt defining a leg-proximal inner edge and a leg-distal outer edge and having at least a length portion in which the inner edge is shorter in length than the outer edge.

15. The safety harness of claim 14, wherein the crotch belt has at least one wedge-shaped tuck in the length portion.

16. The safety harness of claim 14, wherein the crotch belt is separated in the length portions by a transverse cut to define two belt portions, and further comprising at least one bridge band, having opposite ends overlapping confronting ends of the belt portions in a wedge-shaped manner, for connecting the belt portions,

17. The safety harness of claim 15, and further comprising a carrier band connected to the crotch belt in the area of the inner edge for placement upon the tuck.

18. The safety harness of claim 16, and further comprising a carrier band connected to the crotch belt in the area of the inner edge for placement upon the bridge band.

19. The safety harness of claim 14, wherein the crotch belt is made, at least partially, of plastic fibers constructed to shrink under heat exposure, wherein a zone adjacent to the inner edge and a zone adjacent to the outer edge in the length portion of the crotch belt are exposed to a same temperature over different time periods or to different temperatures over a substantially same time period.

20. The safety harness of claim 14, wherein the crotch belt has a woven structure which in the area of the length portion is configured in at least one of a pattern involving an increasing number of wefts extending from the outer edge to the inner edge, and wefts which are thicker in cross section.

21. The safety harness of claim 20, wherein the thicker wefts in cross section are configured as monofilaments.

22. The safety harness of claim 14, wherein the crotch belt has a woven structure which in the area of the length portion is so configured that warps, which extend from the outer edge to the inner edge have a longitudinal tension which increases gradually or step-by-step.

23. A belt construction for use in a safety harness for restraining a person, comprising a belt having opposite belt edges and including at least a length portion in which one of the edges is shorter in length than the other one of the edges to impart the belt with an arcuate configuration.
